(19) United States
(12) Patent Application Publication
(10) Pub. No.: US 2023/0202390 A1
(43) Pub. Date: Jun. 29, 2023

(54) ACCESSORY CONTROL SYSTEM FOR VEHICLE

(71) Applicant: Acumen Robot Intelligence, Inc., Diamond Bar, CA (US)

(72) Inventor: Shuang Xu, Diamond Bar, CA (US)

(21) Appl. No.: 17/561,036

(22) Filed: Dec. 23, 2021

(51) Int. Cl. B60R 1/04; B60R 1/22

(52) U.S. Cl. CPC B60R 1/04; B60R 1/22; B60R 2001/1215

(57) ABSTRACT

An accessory control system for a vehicle includes a rearview mirror assembly having a display and touch screen and a processor, and a control panel assembly connected with the rearview mirror assembly, the control panel assembly having a control panel, a plurality of switch modules communicated with a plurality of corresponding accessory modules; wherein the processor panel receives instructions and sends the instructions to the control panel that causes the control panel to: activate the switch modules, in response to the activation of the switch modules, activating the accessory modules.

### FIELD OF THE DISCLOSURE

The present disclosure relates to an accessory control system, and more particularly, to the accessory control system designated to the vehicle. The rearview mirror assembly may be coupled to a rearview mirror position. It is particularly suitable for controlling the accessories through an input/output interface (a display and touch screen of the rearview mirror assembly) without utilizing physical switch button units.

### BACKGROUND OF THE DISCLOSURE

Generally, most vehicles (e.g., off-road vehicles, motor vehicles, watercraft (ships, boats)) may incorporate an accessory control system to control the accessories, such as vehicle lights, fans, alarms, audio electronic devices or speakers, coupled on the vehicle's exterior or interior. The accessories could be various kinds of equipment that could be compatible with the vehicle.

In this type of accessory control system, a physical controller with a plurality of switch buttons may be needed to be connected with a control box designated to be utilized to adjust the vehicle's accessories. In such a manner, the user (the driver) may press or touch the controller to activate or deactivate the vehicle's accessories through the control box.

However, the above-mentioned accessory control system has several drawbacks. Since the accessory control system requires the controller to control the accessories, it should be a problem for arranging the controller in the vehicle's interior. The controller may be randomly displaced inside the vehicle; however, in this way, while the vehicle is running on a bumpy road (or the watercraft is operating on the river), the controller may easily fall from the vehicle. An improved method to secure the controller is to affix the controller to the vehicle. In this improved method, it is a hassle to decide where the controller is intended to be coupled thereon.

There may exist a desire to develop an accessory control system that is easy for the driver (the user) to control the vehicle's accessories and is convenient to be affixed on the vehicle.

All referenced patents, applications, and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY OF THE DISCLOSURE

In a general implementation, the accessory control system for a vehicle includes a rearview mirror assembly having a display and touch screen and a processor; and a control panel assembly connected with the rearview mirror assembly, the control panel assembly having a control panel, a plurality of switch modules communicated with a plurality of corresponding accessory modules; wherein the processor receives instructions and sends the instructions to the control panel that causes the control panel to: activate the switch modules, in response to the activating of the switch modules, activating the accessory modules.

In another aspect combinable with the general implementation, the display and touch screen is connected with the processor, and the display and touch screen obtains and sends the instructions to the processor.

In another aspect combinable with the general implementation, the control panel assembly is wiredly connected with the rearview mirror assembly.

In another aspect combinable with the general implementation, the control panel assembly comprises a first Bluetooth module wirelessly connected with a second Bluetooth module of the rearview mirror assembly.

In another aspect combinable with the general implementation, the rearview mirror assembly further comprises a plurality of cameras connected with the processor, and the cameras are configured to capture one or more images.

In another aspect combinable with the general implementation, the rearview mirror assembly further comprises a GPS module connected with the processor, wherein the GPS module recognizes the current location and provides a route direction based on at least destination information.

In another aspect combinable with the general implementation, the rearview mirror assembly further comprises a first Wi-Fi module that is connected with an external device.

In another aspect combinable with the general implementation, the control panel is connected with the switch modules and is wirelessly connected with the rearview mirror assembly.

In another aspect combinable with the general implementation, the control panel assembly further comprises a second Wi-Fi module that is connected with an external device.

In another aspect combinable with the general implementation, the control panel assembly further comprises a switch button unit connected with the control panel.

In another aspect combinable with the general implementation, the switch button unit receives the instructions and sends the instruction to the control panel.

In another aspect combinable with the general implementation, the rearview mirror assembly further comprises a memory module connected with the processor, wherein the memory module stores images captured by a plurality of cameras connected with the processor.

In another aspect combinable with the general implementation, the rearview mirror assembly further comprises a GPS module connected with the processor, wherein the GPS module measures the speed of the vehicle and generates speed information that is stored in a memory module.

In another aspect combinable with the general implementation, the control panel assembly further comprises an adjusting module connected with the accessory modules, wherein the adjusting modules is configured to enhance or weaken functional effects of the accessory modules.

In another aspect combinable with the general implementation, the accessory module comprises lights having a plurality of light sources operable to emit a plurality of light distribution patterns.

In another aspect combinable with the general implementation, the instructions cause the control panel to: deactivate the switch modules, in response to the deactivation of the switch modules, deactivating the accessory modules.

In another aspect combinable with the general implementation, the accessory module comprises lights having a plurality of light sources operable to emit a plurality of light distribution patterns.

In another aspect combinable with the general implementation, the external device provides an application or a webpage that is designated to control functions of the accessory modules. In another aspect combinable with the general implementation, the rearview mirror assembly further comprises a universal bracket configured for mounting to an interior portion of the vehicle.

While this specification contains many specific implementation details, these should not be construed as limitations on the scope of any inventions or what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective of an accessory control system for a vehicle according to an aspect of the embodiment.

FIG. 2 is a perspective view of the accessory control system associated with the vehicle according to an aspect of the embodiment.

FIG. 3 is a block diagram of the accessory control system associated with the vehicle according to an aspect of the embodiment.

FIG. 4 is a block diagram of the rearview mirror assembly cooperated with control panel assembly according to an aspect of the invention.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

As used herein, the term “vehicle” may include motor vehicles (off-road vehicles, cars, trucks, buses) or watercraft (ships, boats). It should be understood that the above-described vehicles are exemplary and any other vehicles can be adopted in various embodiments of this disclosure.

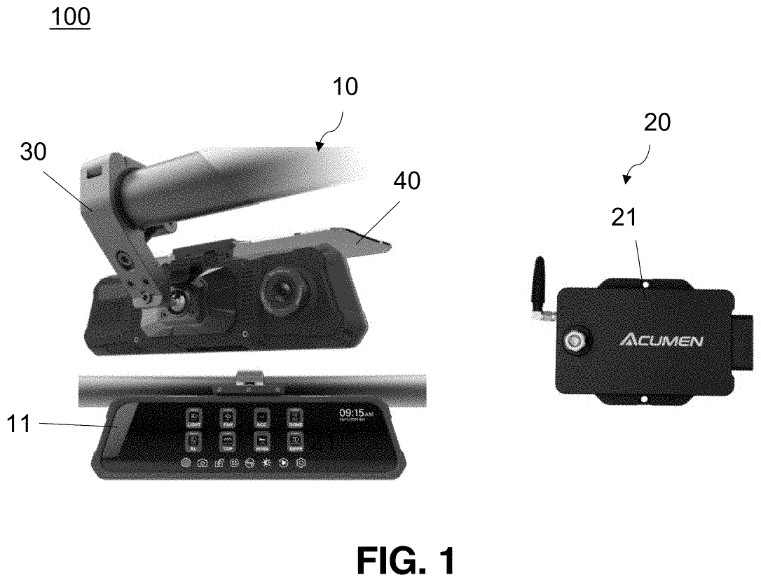

FIG. 1 generally depicts an accessory control system 100 for a vehicle according to an aspect of the embodiment.

Referring to FIG. 1, the accessory control system 100 may comprise a rearview mirror assembly 10 connected with a control panel assembly 20.

In some embodiments, the accessory control system 100 may further comprise a universal bracket 30 that may be configured for mounting to an interior portion of the vehicle and a protection screen 40 selectively coupled on the rearview mirror assembly 10.

In some embodiments, the rearview mirror assembly 10 may comprise a display and touch screen 11 that may be selectively coupled with the protection screen 40. In such a manner, the display and touch screen 11 may be protected under the protection screen 40 to prevent scratching and cracking.

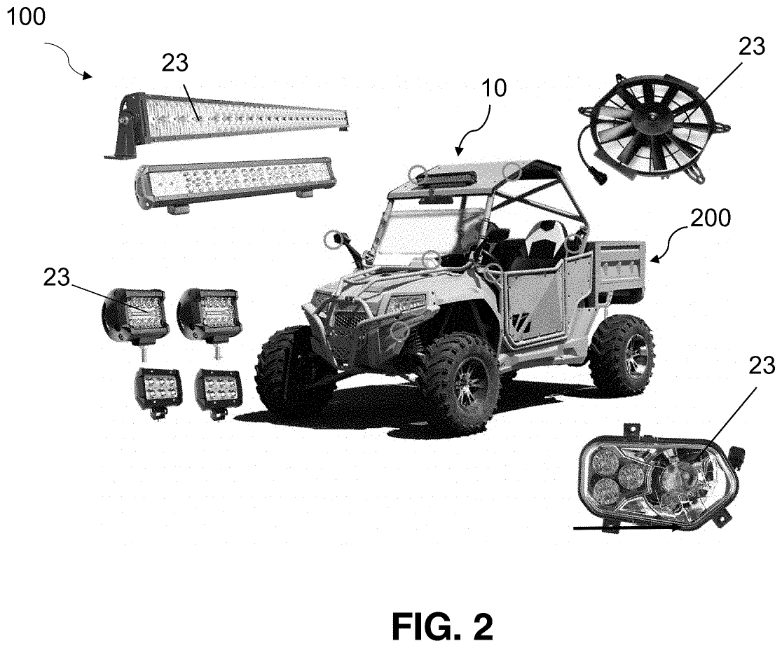

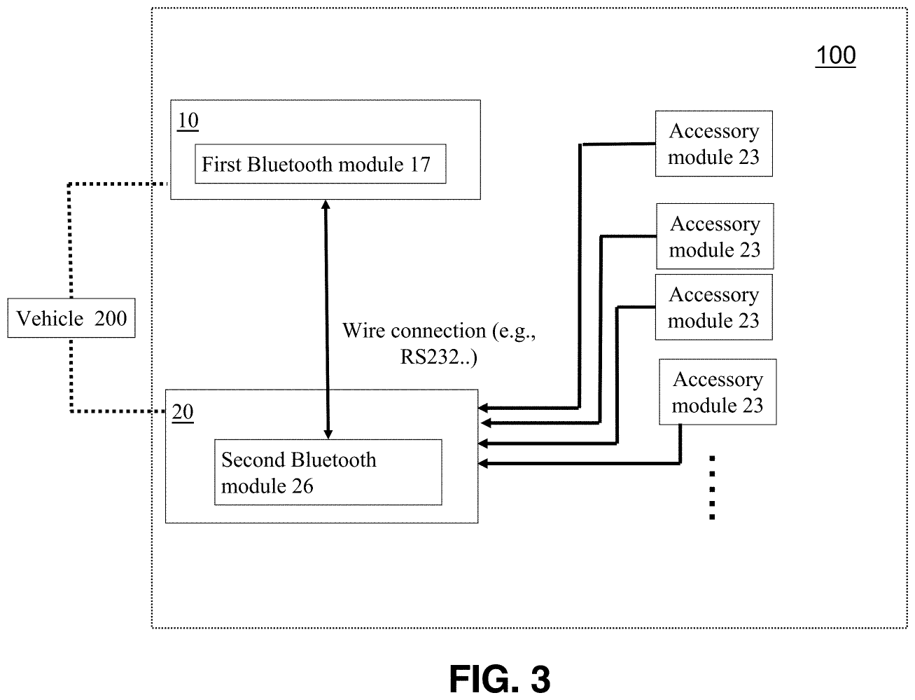

FIGS. 2 and 3 generally depict the accessory control system 100 associated with the vehicle 200 according to an aspect of the embodiment.

Referring to FIGS. 2 and 3, the control panel assembly 20 may comprise a control panel 21 (as shown in FIG. 1) and a plurality of accessory modules 23, wherein the plurality of accessory modules 23 may include fans, different types of lights, such as headlights, fog lights, taillights, or roof lights, alarms, horns, audio electronic devices, or speakers. The accessory modules 23 may be arranged on an interior position or/and an external position of the vehicle 200. It should be noted that the rearview mirror assembly 10 may be coupled on a position where the rearview mirror is located on the vehicle 200. In such a manner, the rearview mirror assembly 10 may be designated to be a rearview mirror for the vehicle 200.

It should be understood that the above-described accessory modules 23 are exemplary and any other accessory modules 23 can be adopted in various embodiments of this disclosure. The number of the accessory modules 23 is not limited, and more than a hundred accessory modules 23 may be utilized in the present invention.

In some embodiments, the rearview mirror assembly 10 may be wirelessly connected with the control panel assembly 20. For example, the rearview mirror assembly 10 may comprise a first Bluetooth module 17 wirelessly connected with a second Bluetooth module 26 of the control panel assembly 20. For another example, the rearview mirror assembly 10 may be wiredly connected with the control panel assembly 20 through the RS232 (recommended standard) adapter. The above-described RS232 adapter connection is exemplary, and any other wireless connection method can be adopted in various embodiments of this disclosure.

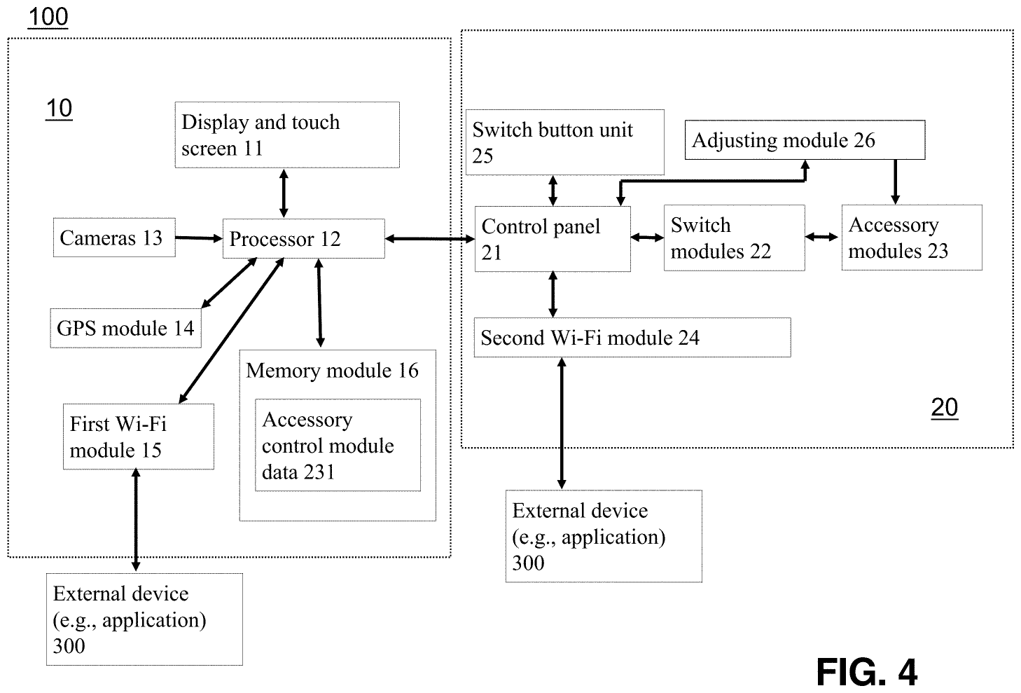

FIG. 4 generally depicts a block diagram of the rearview mirror assembly 10 associated with control panel assembly 20 according to an aspect of the invention.

Referring to FIG. 4, the rearview mirror assembly 10 may further comprise a processor 12 connected with the display and touch screen 11. In such a manner, the user may input instructions into the display and touch screen 11, and the display and touch screen 11 may obtain the instructions and may send the instructions to the processor 12.

In some embodiments, the rearview mirror assembly 10 may further comprise a plurality of cameras 13 connected with the processor 12, wherein the cameras 13 may be configured to capture one or more images around the vehicle 200 (as shown in FIGS. 2 and 3). For example, the cameras 13 may capture front images, rear images, right images, or left images around the vehicle 200, and the images may be transmitted to the display and touch screen 11 to allow the driver to realize the peripheral environment of the vehicle 200.

In still some embodiments, the rearview mirror assembly 10 may further comprise a GPS module 14 connected with the processor 12, wherein the GPS module 14 could recognize the current location and provide a route direction based on at least destination information. For example, the route direction may be transmitted to the display and touch screen 11, and the driver may realize the current locations and may follow the route direction to the desired destination.

It should be noted that, in some embodiments, the GPS module 14 may measure a speed of the vehicle 200 (as shown in FIGS. 2 and 3) and then to generate speed information. In such a way, the speed information may be transmitted to the display and touch screen 11 to allow the driver to realize the speed of the vehicle 200.

Continuing to FIG. 4, the rearview mirror assembly 10 may further comprise a memory module 16 connected with the processor 12, wherein the memory module 16 may store images captured by the plurality of cameras 13 connected with the processor 12. For another example, the speed information may be stored in the memory module 16.

Accordingly, the memory 16 may further store accessory control module data 231 that may include more than one hundred accessory control modules in responsive to the accessory modules 23. In such a manner, the rearview mirror assembly 10 may cooperate with more than one hundred accessory modules 23 without further modification.

In some embodiments, the memory module 16 may be a TF card (TransFlash card). For another example, the memory module 16 may be an SD card. It should be understood that the above-described memory module 16 is exemplary, and any other memory module 16 can be adopted in various embodiments of this disclosure.

From the above descriptions, the rearview mirror assembly 10 may further comprise a first Wi-Fi module 15 that may be connected with an external device 300, wherein the external device 300 may be a mobile device that may include an application. For example, the application may be designated to generate the instructions.

In other words, the external device 300 may be an input/output interface that may transfer instructions, commands, or data input by the user (e.g., at least one of the sensors, a keyboard, or touchscreen) to the processor 12.

Accordingly, the control panel assembly 20 may be wirelessly connected with the rearview mirror assembly 10. For example, the control panel assembly 20 may be wirelessly connected with the rearview mirror assembly 20 through the RS232 (recommended standard) adapter. According to the wireless connection of FIG. 3, the above-described RS232 adapter connection is exemplary, and any other wireless connection method can be adopted in various embodiments of this disclosure.

With specific reference to FIG. 4, the control panel assembly 20 may comprise a control panel 21, which may be wirelessly connected with the processor 12 of the rearview mirror assembly 10. In some embodiments, the control panel assembly 20 may further comprise a plurality of switch modules 22 connected with control panel 21, and each one of the switch modules 22 may be communicated with each one of the corresponding accessory modules 23.

In some embodiments, the external device 300 connected with the first Wi-Fi module 15 may generate the instructions, commands, or data that may be sent to the processor 12, and then the instructions, commands, or data may be sent to the control panel 21 to activate or deactivate the switch modules 22. Since the switch modules 22 may communicate with the corresponding accessory modules 23, in response to the activating of the switch modules 22, the accessory modules 23 may be automatically activated.

From the above descriptions, the instructions, commands, or data may activate the accessory modules 23 to perform different functions, such as turning on the fans, turning on the lights, turning on the alarms, turning on the horns, turning on the audio electronic devices, or turning on the speakers.

It should be understood that the above-described functions are exemplary, and any other functions can be adopted in various embodiments of this disclosure.

In other words, in some embodiments, the instructions, commands, or data may cause the control panel 21 to deactivate the switch modules 22. Since the switch modules 22 may communicate with the corresponding accessory modules 23, in response to the deactivating of the switch modules 22, the accessory modules 23 may be deactivated.

From the above descriptions, the instructions, commands, or data may deactivate the accessory modules 23 to perform different functions, such as turning off the fans, turning off the lights, turning off the alarms, turning off the horns, turning off audio electronic devices, or turning off the speakers.

From the above descriptions of FIG. 4, the control panel assembly 20 may further comprise an adjusting module 26 connected with the accessory modules 23, wherein the adjusting module 26 is connected with the control panel 21. It should be noted that, in one embodiment, the adjusting module 26 may be configured to enhance or weaken functional effects of the accessory modules 23. The functional effects may include lighting effects or sound effects of the accessory modules 23 (e.g., lights or speaker). According to the accessory modules 23 of FIG. 4, for one example, when the accessory module 23 is a light, the light may comprise a plurality of light sources, wherein the light sources may be operable to emit a plurality of light distribution patterns. For example, the light distribution patterns may include flashing light patterns, zoomable light patterns, high-intensity light patterns, or low-intensity light patterns. The instructions, commands, data may be sent to the adjusting module 26 to selectively activate or deactivate the light to perform corresponding light pattern effects.

In a known manner, the control panel assembly 20 may further comprise a second Wi-Fi module 24 that may be enabled to connect with the external device 300. For example, the external device 300 may be an input/output interface which may transmit instructions, commands, or data which are input by the user (e.g., at least one of the sensors, a keyboard or touchscreen) to the control panel 21.

The external device 300 may output, instructions, commands, or data received from the control panel 21. For example, the external device 300 may output images captured by the cameras 13 while the images 13 captured by the cameras 13 are transmitted to the processor 12, and further are transmitted to the control panel 21.

Accordingly, the external device 300 may be a mobile device which may include an application. For example, the application may be designated to generate the instructions, commands, or data which are input by the user. For another example, the external device 300 may include a webpage designated to generate instructions, commands, or data which are input by the user. In this way, the user may use the external device 300 to control functions of the accessory modules 23. Continuing to FIG. 4, the control panel assembly 20 may further comprise a switch button unit 25 connected with the control panel 21, wherein the switch button unit 25 may be physical buttons that could allow the user to input instructions, commands, or data. In other words, the switch button unit 25 may receive the instructions, commands, or data and then send the instruction, commands to the control panel 21.

According to the above descriptions, the accessory modules 23 may be controlled by at least three types of methods. The first method is to use the external device 300 (e.g., the application) to control or adjust the switch modules 22, and then further automatically activate or deactivate the accessory modules 23. The second method is to use the switch button unit 23 to control or adjust the switch modules 22, and then further automatically activate or deactivate the accessory modules 23. The third method is to use the display and touch screen 11 to transmit the instructions, commands, or data to the processor 12, and the instructions, commands, or data may be received by the processor 12, and further be transmitted to the control panel 21 to control or adjust the accessory modules 23.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of accessory control system for vehicles have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. An accessory control system for a vehicle comprising:
a rearview mirror assembly having a display and touch screen and a processor; and
a control panel assembly connected with the rearview mirror assembly, the control panel assembly having a control panel, a plurality of switch modules communicated with a plurality of corresponding accessory modules;
wherein the processor receives instructions and sends the instructions to the control panel that causes the control panel to:
activate the switch modules,
in response to the activation of the switch modules, activating the accessory modules.

2. The accessory control system of claim 1, wherein the control panel assembly is wiredly connected with the rearview mirror assembly.

3. The accessory control system of claim 1, wherein the control panel assembly comprises a first Bluetooth module wirelessly connected with a second Bluetooth module of the rearview mirror assembly.

4. The accessory control system of claim 1, wherein the display and touch screen is connected with the processor, and the display and touch screen obtains and sends the instructions to the processor.

5. The accessory control system of claim 1, wherein the rearview mirror assembly further comprises a plurality of cameras connected with the processor and the cameras are configured to capture one or more images around the vehicle.

6. The accessory control system of claim 1, wherein the rearview mirror assembly further comprises a GPS module connected with the processor, wherein the GPS module recognizes the current location and provides a route direction based on at least destination information.

7. The accessory control system of claim 1, wherein the rearview mirror assembly further comprises a first Wi-Fi module that is connected with an external device.

8. The accessory control system of claim 1, wherein the control panel is connected with the switch modules and the control panel is wirelessly connected with the processor of the rearview mirror assembly.

9. The accessory control system of claim 1, wherein the control panel assembly further comprises a second Wi-Fi module that is connected with an external device.

10. The accessory control system of claim 1, wherein the control panel assembly further comprises a switch button unit connected with the control panel.

11. The accessory control system of claim 10, wherein the switch button unit receives the instructions and sends the instructions to the control panel.

12. The accessory control system of claim 1, wherein the rearview mirror assembly further comprises a memory module connected with the processor, wherein the memory module stores images captured by a plurality of cameras connected with the processor.

13. The accessory control system of claim 1, wherein the rearview mirror assembly further comprises a GPS module connected with the processor, wherein the GPS module measures a speed of the vehicle and generates speed information that is stored in a memory module.

14. The accessory control system of claim 1, wherein the control panel assembly further comprises an adjusting module connected with the accessory modules, wherein the adjusting module is configured to enhance or weaken functional effects of the accessory modules.

15. The accessory control system of claim 14, wherein the accessory module comprises lights having a plurality of light sources operable to emit a plurality of light distribution patterns.

16. The accessory control system of claim 1, wherein the instructions cause the control panel to:
deactivate the switch modules,
in response to the deactivation of the switch modules, deactivating the accessory modules.

17. The accessory control system of claim 16, wherein the accessory module comprises lights having a plurality of light sources operable to emit a plurality of light distribution patterns.

18. The accessory control system of claim 7, wherein the external device provides an application or a webpage that is designated to control functions of the accessory modules.

19. The accessory control system of claim 9, wherein the external device provides an application or a webpage that is designated to control functions of the accessory modules.

20. The accessory control system of claim 1, wherein the rearview mirror assembly further comprises a universal bracket configured for mounting to an interior portion of the vehicle.
